(19) United States
(12) Patent Application Publication
(10) Pub. No.: US 2023/0226681 A1
(43) Pub. Date: Jul. 20, 2023

(54) Multipurpose Leverage Tool

(71) Applicant: Robert Michael Heely, Rocky Point, NY (US)

(72) Inventor: Robert Michael Heely, Rocky Point, NY (US)

(21) Appl. No.: 17/577,696

(22) Filed: Jan. 18, 2022

(51) Int. Cl. B25G 1/00; B25G 1/10

(52) U.S. Cl. CPC B25G 1/005; B25G 1/105

(57) ABSTRACT

A multipurpose extension device for attachment and coupling with hand tools, such as tire irons, ratchets and wrenches. The device is an elongated hollow rigid tube containing a rectangular notch and narrow channel. Inside the hollow rigid tube contains magnetic materials to assist securing of inserted or coupled tool. Two ends to device, one end containing a handle other end is open receptacle. This receptacle end of the device is for the acceptance and coupling with hand tools such as, ratchets, pry bars and various other hand tools. A wrench can be inserted into the device by sliding in then turning 90 degrees to secure. One purpose of this device is to provide increased leverage and length of hand tools, for the removal and installation of threaded hardware. Additional use of this device is to increase leverage on pry bars, in the separation items such as, machinery gears.

The present application claims priority from Application No. 63/138,862 Filed Jan. 19, 2021

### FEDERALLY SPONSORED RESEARCH

Not Applicable

### JOINT RESEARCH AGREEMENT

Not Applicable

### TECHNICAL FIELD

The present invention relates to extension devices for automotive tools, such as lug wrenches, sockets and ratchets. Purpose being to increase leverage and torque applied to hand tools on low speed, high torque operations. More specifically removal and installation of threaded nuts and bolts. The invention is an extension that increases the length of hand tools, therefore increasing the torque when force is applied. The multipurpose nature of this device takes the place of many power and costly alternatives, while providing streamlined extension into small spaces.

### BACKGROUND OF THE INVENTION

A review of prior art and patents was conduced which reveals prior art patents having similar use. However the prior art inventions do not disclose the same or similar elements as the presented Multipurpose Leverage Tool.

It is know within this filed that torque and leverage of a hand tool is limited due to its length. The addition of a handle to increase length allows the user much more leverage and torque for faster operations. Wrench tools systems that have been produced are mostly limited to specific connections with certain hand tools. What is missing with these prior inventions is a simple one piece rugged design that not only increases the torque, leverage and length but provides multipurpose coupling with many hand tools in a streamlined telescoping manner. Also missing with prior inventions is extensions that allow one hand operations, this device presented here contains magnetic materials along with notch and channel to firmly hold wrenches for one hand operation. One hand operations, such as removing an oil drain plug from an engine is able to be reached from a further distance. This allows the operator faster operations with the multipurpose leverage tool coupled with a wrench or ratchet.

A simple operation such as removal of automobile lug nuts has become very difficult over the years. Earlier automobiles came with lug wrenches that are approximately double the size of today's lug wrenches. This basic task is very difficult for the average person to handle. Other inventions have been issued to assist with this task, such as power tools and double cross lug wrenches. However these inventions do assist with this task, they are not capable of many of the multipurpose tasks that this invention handles. The invention of the multipurpose leverage tool will assist with the removal and installation of automobile lug nuts as well as many other operations.

### SUMMARY OF THE INVENTION

The primary objective of this invention is to provide a tool that may be used with various hand tools for increased leverage, torque and length. This invention is a simple one piece design constructed with a rigid hollow metal tube. This device presented here contains a handle at one end, with a notch and channel in the middle to end of the tube. Opposite the handle is the open end that is the receptacle for receiving the handle of other tools, such as ratchets and tire irons.

The middle notch and channel portion is for the insertion of open and closed end wrenches. The wrench is inserted into the channel in the device then turned 90 degrees to lock into place. To further secure the wrench inside the tube, magnetic materials are secured under the wrench below the channel inside the tube.

Extensions and leverage devices are applied to hand tools to allow the user to increase the amount of leverage and torque applied to the hand tool. These extensions are also used to reach objects that are further away and cannot be reached by one hand tool. These devices are applied to nuts and bolts that are frozen or difficult to turn, and applied in reverse to reinstall. Other bolts such as threaded hardware to install wall brackets into wall studs are very difficult to install and remove; increase torque is required on both operations.

Additional leverage is required for separation of two adjoined objects such as an automotive suspension part repair. Pry bars are used for leverage and this invention extends the length of the pry bar to increase the leverage required to free the object, such as suspension parts.

The size of the invention can range from several inches to several feet; the example illustrated in this application is approximately 1 foot in length. The construction of the invention could be a variety of metals, but in this application it is steel. The handle of the invention can be also a variety of materials, but in the examples listed here it is made of steel and welded to the outside of the tube. Inside the invention contains magnetic materials that can be of many types and strengths, the examples in this application are two metal magnets secured to the inner tube by high grade epoxy.

The invention present here with a combined or coupled hand tool will increase its length and provide additional leverage, torque when force is applied. This invention combines strength and flexibility to accommodate the coupling with a variety of hand tools. Flexibility of torque with this invention is achieved by the ability to expand or collapse the coupled hand tool. For example this invention when coupled with a ratchet can be collapsed to fit in a small space, and then extended longer for more torque. Basic automobile brake repairs are in tight spaces that require large amounts of torque; this invention greatly assists with that task. The storage of this invention is assisted by a hole near the handle for possibly hanging or securing when not in use.

Additional details and advantages of the present invention will become clear after reading and viewing the accompanying drawings.

### BRIEF DESCRIPTION OF THE DRAWINGS

The various drawings, which are not necessarily drawn to scale, numerals throughout the figures identify the components.

FIG. 1 is a side view drawing of the multipurpose leverage tool;

FIG. 2 is the handle attached to the top of the tool;

FIG. 3 is the magnets secured inside the tool;

FIG. 4 is the hole in the side of the tool;

FIG. 5 is the notch in the middle of the tool;

FIG. 6 is the channel at the receptacle end of the tool;

FIG. 7 is of end view of handle end of the tool;

FIG. 8 is the handle show with end view of the tool;

FIG. 9 is the magnet show with end view of the tool;

FIG. 10 is the receptacle end view of the tool:

FIG. 11 is the handle show at from the receptacle end of the tool:

FIG. 12 is the channel at receptacle end of the tool;

FIG. 13 is the magnet show from receptacle end of the tool;

FIG. 14 is the top view of the tool;

FIG. 15 is a tire iron inserted into the receptacle end of the tool;

FIG. 16 is a wrench inserted inside the body of the tool;

### DETAILED DESCRIPTION

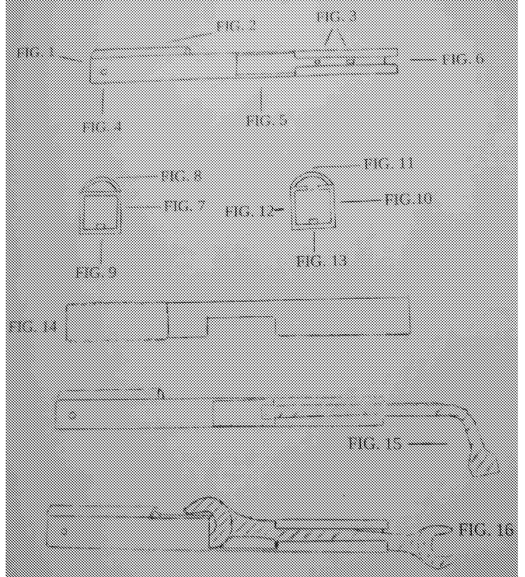

FIG. 1 through 16 shows a first embodiment of the present invention. The construction of the embodiment illustrated is steel. FIG. 1 through 16 shows the square tube steel construction; various shapes of tubes are also used with same components. Strong construction is an important element due to the force applied during use.

Size of the tube varies according to the operations anticipated; the size illustrated in FIG. 1 through 16 is 11 inches long and 1 inch in diameter, not necessarily shown to scale. FIG. 2 illustrates the handle that is attached to the tube, attachment maybe welded or similar attachment methods. This handle FIG. 2 is approximately 3-4 inches in length and approximately half the width of the device. FIG. 3 Inside the channel at the bottom are the magnets that are secured by own strength as well as high grade epoxy. Below the handle is a hole is on both sides for storage as shown in FIG. 4.

The middle of the tool contains a rectangular notch that has is approximately 2 inches in length and the entire width of the tool as shown in FIG. 5. This is the receptacle for a open or closed end wrench to be placed. The wrench FIG. 16 would be first inserted into the channel FIG. 6 then turned 90 degrees to lock into the notch while secured by magnets FIG. 3. Magnets hold all devices that are coupled with this tool to allow more stability and better one hand use.

FIG. 14 is the top view of the tool showing the handle FIG. 2 and the notch FIG. 5. The channel FIG. 6 and magnets FIG. 3 are not able to be seen from this view.

FIG. 15 is a tire iron inserted into the receptacle end of the tool under channel FIG. 6. This tool is secured by the magnets located under the channel inside the body of the tool FIG. 3. The diameter of this tool is approximately 1 inch square, which provides enough room for various size lug wrenches. FIGS. 15 & 16 are just two examples of hand tools that can be coupled and attached to this invention. Many other tools, such as oil filter wrenches, pry bars, and ratchets also fit securely inside the end of the too.

### REFERENCES

U.S. Patent Documents

| | | |
|---|---|---|
| 987314 | January 2018 | Bolivar |
| 5,685,207 | November 1997 | Hubert |
| 10/994,400 | May 2021 | Bar |
| 897811 | May 2018 | Rau |
| 10/611,014 | April 2020 | Lacarov |
| 8,746,112 | June 2014 | Perry, Ruff |
| 6,308,596 | October 2001 | Williams |
| 5,279,189 | January 1994 | Marino |
| 4,334,445 | June 1982 | Timewell |
| 6,112,625 | September 2000 | Turtle |
| 5,911,798 | June 1999 | Arnold |
| 420557 | February 2000 | Paris |
| 6,134,413 | November 2000 | Lin |
| 9,452,513 | September 2016 | Kravitch |
| 8,307,741 | November 2012 | Alvarez |
| D363419 | October 1995 | Dixon |
| 7,340,981 | September 2005 | Bryce |
| 9,950,411 | January 2015 | Clover |

1. A multipurpose hand tool extension device, comprising:
an hollow rigid metal elongated tube, having first and second opposite ends;
a handle attached in the first end of the tube.
a open end and channel at the opposite end of the tube, shaped and tapered to receive a tool handle:
a notch located at center of the tube, wherein said notch connects with channel, shaped and tapered to receive a wrench head.

2. the device for extension of claim 1, wherein said device contains attached magnetic materials inside center of said device.

3. the device for extension of claim 2, wherein said device contains a hole below handle in said device.
